(19) United States
(12) Patent Application Publication
(10) Pub. No.: US 2025/0138144 A1
(43) Pub. Date: May 1, 2025

(54) Time Division Duplexed Frequency Modulation Continuous Wave Radar System

(71) Applicant: KaiKuTek INC., Taipei (TW)

(72) Inventors: Mike Chun-Hung Wang, Taipei (TW); Yi-Chu Chen, Taipei (TW); Tun-Yen Liao, Taipei (TW); Zi-Hao Fu, Taipei (TW); Hsiang-Chieh Jhan, Taipei (TW); Yi-Ting Tseng, Taipei (TW); Chun-Hsuan Kuo, Taipei (TW); Wei-Chi Li, Taipei (TW); Sheng-Tse Tai, Taipei (TW); Wei-Ming Sun, Taipei (TW); Pei-Ming Cai, Taipei (TW)

(73) Assignee: KaiKuTek INC., Taipei (TW)

(21) Appl. No.: 18/896,956

(22) Filed: Sep. 26, 2024

Related U.S. Application Data
(60) Provisional application No. 63/594,418, filed on Oct. 30, 2023.

(51) Int. Cl. G01S 7/03; G01S 7/35; G01S 13/58

(52) U.S. Cl. CPC G01S 7/034; G01S 7/356; G01S 13/584

(57) ABSTRACT

A time division duplexed (TDD) frequency modulation continuous wave (FMCW) radar system includes P transmitter circuit chains and M receiver circuit chains. The P transmitter circuit chains are used to transmit a plurality of FMCW signals. A pth transmitter circuit chain is coupled to a single pole Op throw (SPQPT) radio frequency (RF) switch, the SPOT RF switch is coupled to Op antennas, Qp and P are positive integers, and p is a positive integer not larger than P. The M receiver circuit chains are used to receive a plurality of reflected FMCW signals. An mth receiver circuit chain is coupled to a single pole Nm throw (SPNmT) radio frequency (RF) switch, the SPNmT RF switch is coupled to Nm antennas, Nm and M are positive integers, and m is a positive integer not larger than M.

### CROSS REFERENCE TO RELATED APPLICATIONS

This application claims the benefit of U.S. Provisional Application No. 63/594,418, filed on Oct. 30, 2023. The content of the application is incorporated herein by reference.

### BACKGROUND OF THE INVENTION

### 1. Field of the Invention

The invention is related to a frequency modulation continuous wave (FMCW) system, in particularly, to a time division duplexed (TDD) FMCW system.

### 2. Description of the Prior Art

A frequency modulated continuous wave (FMCW) radar system is a special type of radar system that measures both distance and velocity of moving objects. The measurement is achieved by continuously varying the frequency of the transmitted signal by a modulating signal at a known rate over a fixed time period. A variety of frequency modulation techniques, such as sawtooth modulation, triangular modulation, sine wave modulation, square wave modulation, and stepped modulation, can be used in FMCW radar system. Sawtooth and triangular wave modulations are most widely used to change the frequency pattern of the FMCW radar system.

FMCW radar systems measure the frequency difference (Δf, due to time of flight) between the transmitted and received echo signal for calculating the distance, and it also measures the phase difference of a motion of an object for calculating the velocity of the object.

In a 1T1R FMCW radar system, the transmitter antenna emits FMCW signals, and the reflected FMCW signals from the target are received by the receiver antenna. The output of the receiver antenna is given to the mixer of the receiver circuit chain via a low noise amplifier. In the mixer circuit, a part of the transmitted FMCW signal is mixed with the reflected FMCW signal, producing an intermediate frequency (IF) signal, which can be used to determine the distances and/or velocities of the objects according to the frequency differences and phase differences of the objects. The frequency of the IF signal is the difference between the frequency of the transmitted FMCW signal and reflected FMCW signal.

However, a 1T1R FMCW radar system is not enough to analyze the angles of objects. Multiple transmitter antennas and multiple receiver antennas provide better angular information for analyzing the direction of the objects. Conventional multiple transmitting and receiving antennas use multiple transmitter circuit chains and multiple receiver circuit chains, one dedicated transmitter chain for each transmitter path and one dedicated receiver chain for each receiver path, thus the FMCW radar system consumes a lot of power and takes a lot of area.

### SUMMARY OF THE INVENTION

An embodiment provides a time division duplexed (TDD) frequency modulation continuous wave (FMCW) radar system. The TDD FMCW radar system includes P transmitter circuit chains and M receiver circuit chains. The P transmitter circuit chains are used to transmit a plurality of FMCW signals. A pth transmitter circuit chain is coupled to a single pole Op throw (SPORT) radio frequency (RF) switch, the SPQPT RF switch is coupled to Op antennas, Qp and P are positive integers, and p is a positive integer not larger than P. The M receiver circuit chains are used to receive a plurality of reflected FMCW signals. An mth receiver circuit chain is coupled to a single pole Nm throw (SPNmT) radio frequency (RF) switch, the SPNmT RF switch is coupled to Nm antennas, Nm and M are positive integers, and m is a positive integer not larger than M.

Another embodiment provides a method for time division duplexed (TDD) frequency modulation continuous wave (FMCW) radar system. The method includes transmitting a plurality of FMCW signals through P transmitter circuit chains, wherein a pth transmitter circuit chain is coupled to a single pole Op throw (SPQPT) radio frequency (RF) switch, the SPQPT RF switch is coupled to Op antennas, Qp and P are positive integers, and p is a positive integer not larger than P; and receiving a plurality of reflected FMCW signals through M receiver circuit chains, wherein an mth receiver circuit chain is coupled to a single pole Nm throw (SPNmT) radio frequency (RF) switch, the SPNmT RF switch is coupled to Nm antennas, Nm and M are positive integers, and m is a positive integer not larger than M.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a 1T1R frequency modulation continuous wave (FMCW) radar system according to an embodiment of the present invention.

FIG. 2 is a schematic diagram for range measurement of the 1T1R frequency modulation continuous wave (FMCW) radar system in FIG. 1 according to an embodiment of the present invention.

FIG. 3 is a schematic diagram for velocity measurement of the 1T1R frequency modulation continuous wave (FMCW) radar system in FIG. 1 according to an embodiment of the present invention.

FIG. 4 is a schematic diagram for angle measurement of a 1T2R frequency modulation continuous wave (FMCW) radar system according to an embodiment of the present invention.

FIG. 5 is a block diagram of an RF frontend circuit of a 4T4R time division duplexed (TDD) FMCW radar system according to an embodiment of the present invention.

FIG. 6 is a timing diagram of the 4T4R TDD FMCW radar system with the frontend circuit in FIG. 5 according to an embodiment of the present invention.

### DETAILED DESCRIPTION

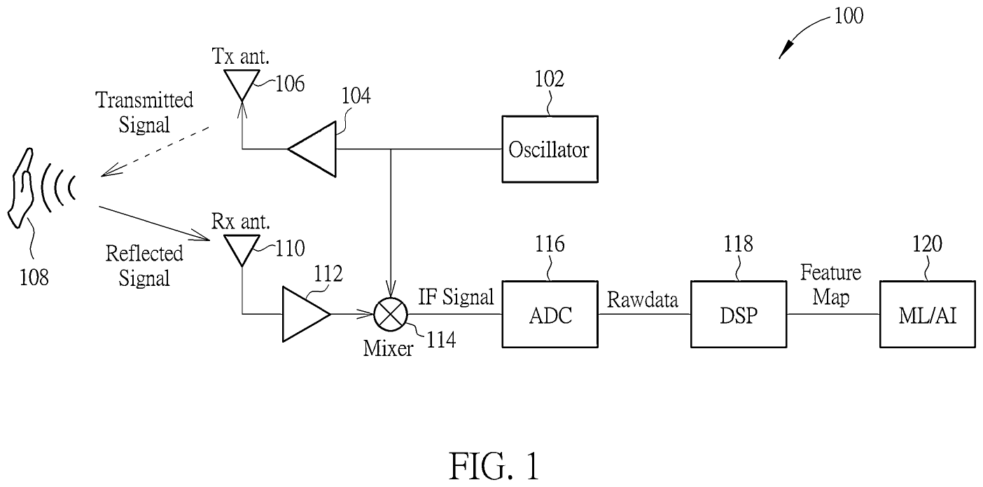

FIG. 1 is a block diagram of a 1T1R frequency modulation continuous wave (FMCW) radar system 100 according to an embodiment of the present invention. The 1T1R FMCW radar system 100 includes an oscillator 102, a power amplifier 104, a transmitter antenna 106, a receiver antenna 110, a low noise amplifier 112, a mixer 114, an analog to digital converter (ADC) 116, a digital signal processing (DSP) processor 118, and a machine learning (ML)/artificial intelligence (AI) processor 120. The oscillator 102 generates an FMCW signal with sawtooth modulation, triangular modulation, sine wave modulation, square wave modulation, or stepped modulation for the mixer 114 and the power amplifier 104. In another embodiment, the oscillator 102 can be a radio frequency (RF) phase-locked loop. The power amplifier 104 amplifies the FMCW signal to generate an amplified FMCW signal to the transmitter antenna 106. The transmitter antenna 106 transmits the transmitted signal using an amplified FMCW signal to detect an object 108. The object 108 reflects the transmitted signal to generate a reflected signal to the receiver antenna 110. The receiver antenna 110 receives the reflected signal to generate a receiving signal to the low noise amplifier 112. The low noise amplifier 112 amplifies the receiving signal to generate an amplified receiving signal for the mixer 114. The mixer 114 mixes the FMCW signal with the amplified receiving signal to generate an intermediate frequency (IF) signal for the ADC 116. The ADC 116 receives the IF signal and converts it into digital raw data for the DSP processor 118. The DSP processor 118 performs DSP on the digital raw data to generate a feature map for the ML/AI processor 120. The ML/AI processor 120 analyzes the feature map by an ML model to generate an analyzed result.

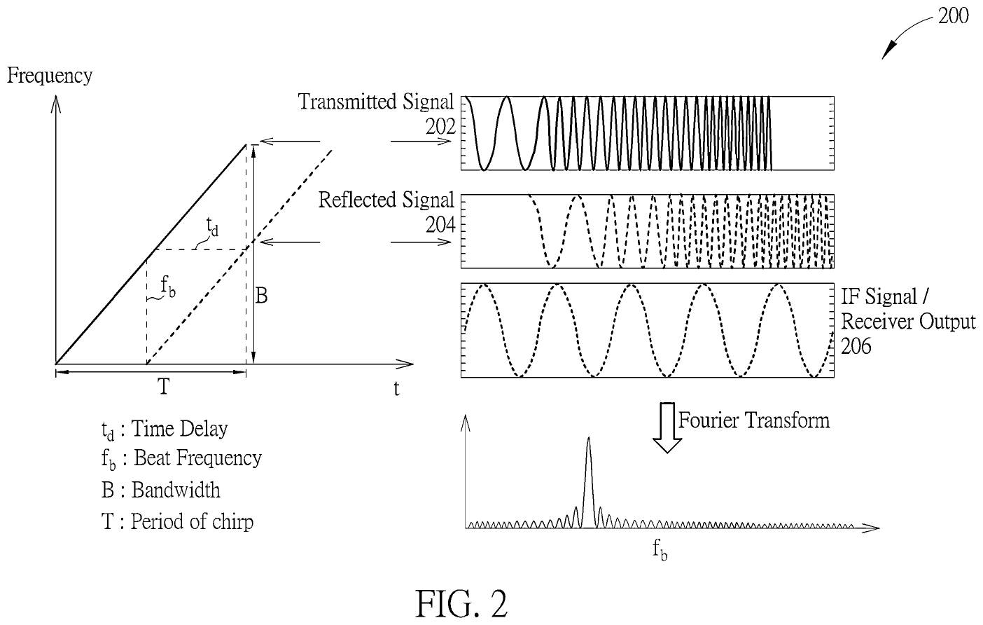

FIG. 2 is a schematic diagram 200 for range measurement of the 1T1R frequency modulation continuous wave (FMCW) radar system 100 according to an embodiment of the present invention. In this embodiment, the FMCW signal is a chirp signal with a bandwidth B and a period of chirp T. In FIG. 2, there is a time delay t_{d} between a transmitted signal 202 and a reflected signal 204 due to the range R between the 1T1R FMCW radar system 100 and the object 108. Therefore, the time delay t_{d} can be defined as follows:

$${t}_{d} = \frac{2 R}{c}$$

where c is the speed of light.

In the FMCW radar system 100, the time delay t_{d} is derived with the following approach. The time delay t_{d} causes a frequency offset f_{b} (the beat frequency) between the transmitted signal 202 and the reflected signal 204 since the signals are modulated as chirps. Therefore, with the mixer 114 mixing the transmitted signal 202 and the reflected signal 204 to generate an intermediate frequency (IF) signal 206, the beat frequency f_{b} can be obtained by performing fast Fourier transform (FFT) on the IF signal 206. The slope of chirp is a constant, so the time delay t_{d} can be also calculated as follows:

$${t}_{d} = {f}_{b} \times \frac{T}{B} = \frac{2 R}{c}$$

Therefore, the range R can be calculated as follows:

$$R = \frac{{cf}_{b} T}{2 B}$$

where c is the speed of light, f_{b} is the beat frequency measured from the IF signal 206, T is the period of chirp, and B is the bandwidth of chirp.

By using this formula, the range of an object can be determined. If there are multiple objects with different ranges detected by the FMCW radar system, there will be multiple peaks in the FFT spectrum of IF signal. Each peak can generate a range by

$$R = \frac{{cf}_{b} T}{2 B} ,$$

thus generating all ranges of the objects.

In addition, the range resolution and the maximum range of the FMCW radar system 100 can be estimated as follows:

$${R}_{res} = \frac{c}{2 B} , {R}_{max} = \frac{{F}_{s} cT}{2 B}$$

where c is the speed of light, B is the bandwidth of chirp, T is the period of chirp, and Fₛ is the sampling frequency of the analog to digital convertor (ADC). Therefore, the range resolution can be designed according to the bandwidth B, and the maximum detecting range can be defined by the sampling frequency Fₛ of the ADC.

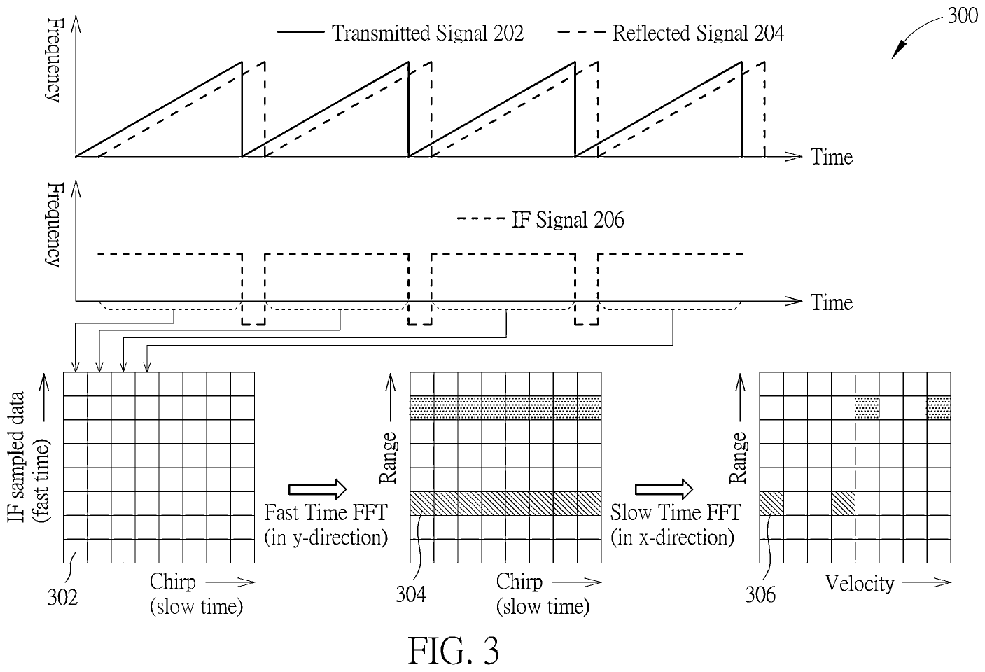

FIG. 3 is a schematic diagram 300 for velocity measurement of the 1T1R frequency modulation continuous wave (FMCW) radar system 100 according to an embodiment of the present invention. The transmitter transmits N chirps in the transmitted signal 202, and the receiver receives N chirps in the reflected signal 204. When an object is moving, the phase differences of the IF signal 206 among N chirps can be calculated as:

$$phase difference ω = \frac{4 π vT}{λ}$$

where ω is the phase difference, T is the period of chirp, v is the velocity of the object (the direction is away from the radar system), and λ is a wavelength of the FMCW signal.

Therefore, to calculate the phase difference ω is to calculate the velocity of the object v. In FIG. 3, the IF signal 206 can be packaged into packets according to the chirps as shown in IF sampled data 302. Each column contains a chirp signal of the reflected signal 204. Then, perform fast Fourier transform (FFT) on the IF sampled data 302 on the vertical axis (y-direction) to obtain the ranges of the objects in the spectrum 304. The horizontal axis (x-axis) of the spectrum 304 represents slow time, and the vertical axis (y-axis) of the spectrum 304 represents range. In spectrum 304, two ranges can be analyzed from the FFT operation, thus the radar system detects at least two objects. At last, perform FFT on the spectrum 304 on the horizontal axis (x-direction) to obtain the velocities of objects in the diagram 306. The x-axis of the diagram 306 represents velocity, and the y-axis of the diagram 306 represents range. By analyzing the phase differences in the x-axis of the diagram 306, the velocities of the objects can be calculated as follows:

$$velocity {v}_{n} = \frac{{λω}_{n}}{4 π T}$$

where ωₙ is the phase difference of the nth object, T is the period of chirp, vₙ is the velocity of the nth object (the direction is away from the radar system), and λ is a wavelength of the FMCW signal.

In addition, the velocity resolution and the maximum velocity of the FMCW radar system can be estimated as follows:

$${V}_{res} = \frac{λ}{2 {T}_{f}} , {V}_{max} = \frac{λ}{4 T}$$

where λ is the wavelength of the FMCW signal, T is the period of a chirp, and T_{f} is the total measuring time with multiple chirps. Therefore, the velocity resolution can be designed according to the total measuring time T_{f}, and the maximum detecting velocity can be designed by the period of a chirp T.

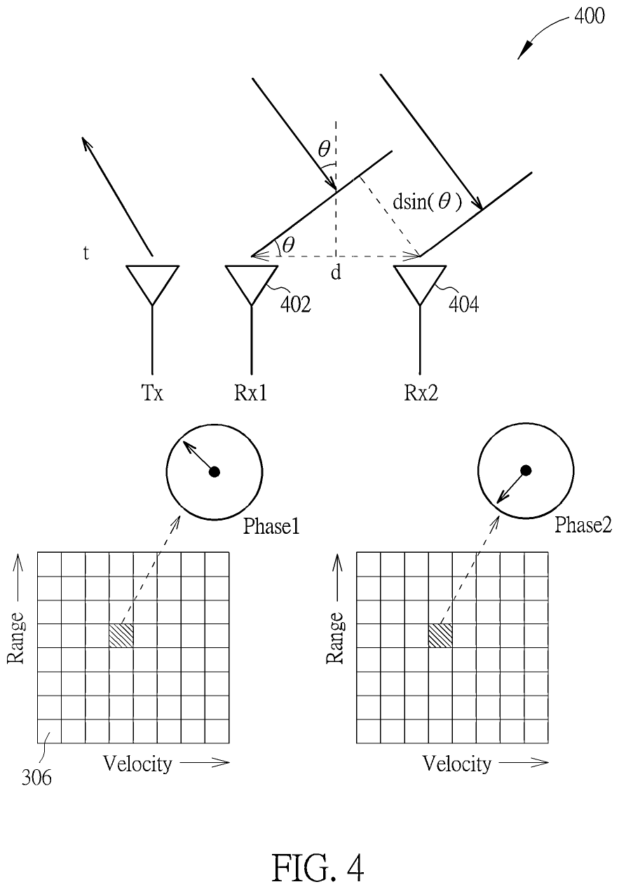

To estimate the angle θ of the detected object, the number of the receiver antennas should be larger than 1. FIG. 4 is a schematic diagram 400 for angle measurement of a 1T2R frequency modulation continuous wave (FMCW) radar system according to an embodiment of the present invention. In this embodiment, there are one transmitter antenna and two receiver antenna. The electromagnetic wave path difference is d sin θ due to the angle of arrival (AoA) θ and the distance d between two receiver antennas, causing a phase difference between the Rx1 402 and the Rx2 404. The phase difference Δϕ can be expressed as follows:

$$Δϕ = \frac{2 π}{λ} d sin θ$$

Where λ is the wavelength of the FMCW signal, d is the distance between the two receiver antennas, and θ is the angel of arrival (AoA) from the object to the FMCW radar system. Therefore, when the range and velocity of an object are obtained in the diagram 306, the phase difference of signals in Rx1 402 and Rx2 404 can be calculated. Then, the angle of arrival (AoA) can be obtained as follows:

$$θ = {sin}^{- 1} ( \frac{λΔϕ}{2 π d} )$$

For an FMCW radar system with multiple receivers (more than 2), the phase differences of signals of the diagram 306 can be analyzed by using an FFT operation to obtain the AoA θ. The peak in the diagram 306 represents object with different velocities and ranges. The results of applying the FFT operation on the signals in multiple receiver antennas in the same peak in velocity and range diagram represents phase differences among the receiver antennas. Therefore, the angle of arrival (AoA) can be estimated with the following equations:

$${θ}_{n} = {sin}^{- 1} ( \frac{λ Δ {ϕ}_{n}}{2 π d} )$$

Where λ is the wavelength of the FMCW signal, dis the distance between the two receiver antennas, θₙ is the angel of arrival (AoA) from the nth object to the FMCW radar system, and Δϕₙ is the phase difference of the nth object.

In addition, the angle resolution and the maximum angle of the FMCW radar system can be estimated as follows:

$${θ}_{res} = \frac{λ}{nd cos θ} , {θ}_{max} = {sin}^{- 1} ( \frac{λ}{2 d} )$$

where λ is the wavelength of the FMCW signal, n is the number of receiver antennas, d is the distance among the receiver antennas, and θ is the dependent angle. Therefore, the distance of antennas is often set to λ/2 to obtain the maximal angle measurement. And the resolution of AoA mainly depends on the number of receiver antennas.

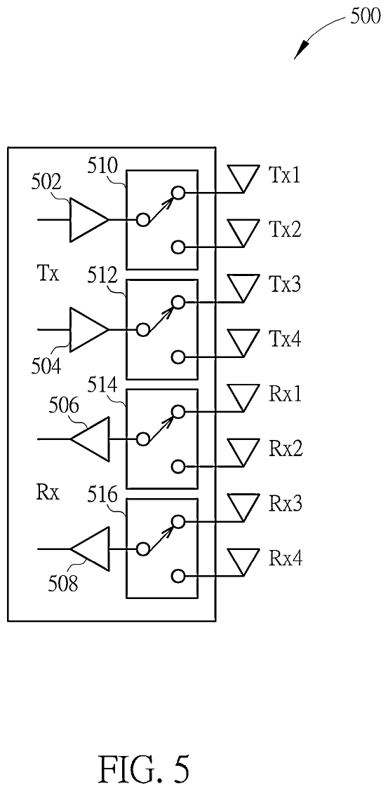

FIG. 5 is a block diagram of an RF frontend circuit 500 of a 4T4R time division duplexed (TDD) FMCW radar system according to an embodiment of the present invention. In this embodiment, the RF frontend circuit 500 includes two power amplifiers 502, 504, two low noise amplifiers 506, 508, four single pole double throw (SPDT) RF switches 510, 512, 514, 516, four transmitter antennas Tx1, Tx2, Tx3, Tx4, and four receiver antennas Rx1, Rx2, Rx3, Rx4. The present invention is not limited to 4T4R, and the RF switches are not limited to SPDT RF switches. The present invention includes a PTMR (P transmitters M receivers) TDD FMCW radar system, and the RF switches can be SPQT RF switches, where P, M, Q are positive integers.

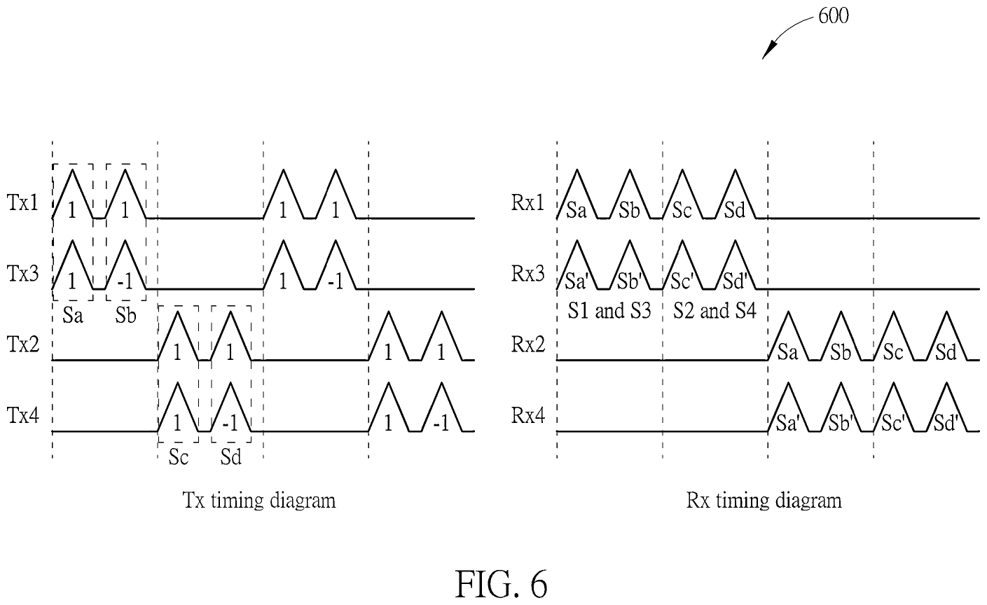

FIG. 6 is a timing diagram 600 of the 4T4R TDD FMCW radar system with the frontend circuit 500 according to an embodiment of the present invention. At first, the SPDT RF switch 510 is coupled to a transmitter antenna Tx1, the SPDT RF switch 512 is coupled to a transmitter antenna Tx3, the SPDT RF switch 514 is coupled to a receiver antenna Rx1, and the SPDT RF switch 516 is coupled to a receiver antenna Rx3. The transmitted FMCW signals transmitted by two transmitter antennas Tx1, Tx3 are modulated by binary phase modulation (BPM) represented by 1 and −1 in FIG. 6. The reflected signal Sa and Sb are combined from the reflected signals S1 and S3 of transmitted signals transmitted by the transmitter antennas Tx1 and Tx3, and the reflected signal Sa′ and Sb′ are combined from the reflected signals S1′ and S3′ of transmitted signals transmitted by the transmitter antennas Tx1 and Tx3. The relationship can be written as follows:

$$Sa = S 1 + S 3 , Sb = S 1 - S 3 , {Sa}^{′} = S {1}^{′} + S {3}^{′} , {Sb}^{′} = S {1}^{′} - S {3}^{′}$$

Therefore, the corresponding receiving signals S1, S3, S1′, and S3′ can be calculated as follows:

$$S 1 = \frac{Sa + Sb}{2} , S 3 = \frac{Sa - Sb}{2} , S {1}^{′} = \frac{{Sa}^{′} + {Sb}^{′}}{2} , S {3}^{′} = \frac{{Sa}^{′} - {Sb}^{′}}{2}$$

The benefit of transmitting signals simultaneously by the transmitter antennas Tx1 and Tx3 with BPM modulation is to increase signal to noise ratio (SNR) by 3 dB, and the benefit of receiving reflected signals simultaneously by the receiver antennas Rx1 and Rx3 is to estimate AoA by the phase difference between the two receiver antennas Rx1 and Rx3. Secondly, the SPDT RF switch 510 is coupled to a transmitter antenna Tx2, the SPDT RF switch 512 is coupled to a transmitter antenna Tx4, the SPDT RF switch 514 is coupled to the receiver antenna Rx1, and the SPDT RF switch 516 is coupled to the receiver antenna Rx3. The transmitted FMCW signals transmitted by the two transmitter antennas Tx2 and Tx4 are modulated by binary phase modulation (BPM) represented by 1 and −1 in FIG. 6. The reflected signal Sc and Sd are combined from the reflected signals S2 and S4 of transmitted signals transmitted by the transmitter antennas Tx2 and Tx4, and the reflected signal Sc′ and Sd′ are combined from the reflected signals S2′ and S4′ of transmitted signals transmitted by the transmitter antennas Tx2 and Tx4. The relationship can be written as follows:

$$Sc = S 2 + S 4 , Sd = S 2 - S 4 , {Sc}^{′} = S {2}^{′} + S {4}^{′} , {Sd}^{′} = S {2}^{′} - S {4}^{′}$$

Therefore, the corresponding receiving signals S2, S4, S2′, and S4′ can be calculated as follows:

$$S 2 = \frac{Sc + Sd}{2} , S 4 = \frac{Sc - Sd}{2} , S {2}^{′} = \frac{{Sc}^{′} + {Sd}^{′}}{2} , S {4}^{′} = \frac{{Sc}^{′} - {Sd}^{′}}{2}$$

Thirdly, the SPDT RF switch 510 is coupled to the transmitter antenna Tx1, the SPDT RF switch 512 is coupled to the transmitter antenna Tx3, the SPDT RF switch 514 is coupled to a receiver antenna Rx2, and the SPDT RF switch 516 is coupled to a receiver antenna Rx4. The transmitted FMCW signals by two transmitter antennas are modulated by binary phase modulation (BPM) represented by 1 and −1 in FIG. 6. The reflected signal Sa and Sb are combined from the reflected signals S1 and S3 of transmitted signals transmitted by the transmitter antennas Tx1 and Tx3, and the reflected signal Sa′ and Sb′ are combined from the reflected signals S1′ and S3′ of transmitted signals transmitted by the transmitter antennas Tx1 and Tx3. The relationship can be written as follows:

$$Sa = S 1 + S 3 , Sb = S 1 - S 3 , {Sa}^{′} = S {1}^{′} + S {3}^{′} , {Sb}^{′} = S {1}^{′} - S {3}^{′}$$

Therefore, the corresponding receiving signals S1, S3, S1′, and S3′ can be calculated as follows:

$$S 1 = \frac{Sa + Sb}{2} , S 3 = \frac{Sa - Sb}{2} , S {1}^{′} = \frac{{Sa}^{′} + {Sb}^{′}}{2} , S {3}^{′} = \frac{{Sa}^{′} - {Sb}^{′}}{2}$$

At last, the SPDT RF switch 510 is coupled to the transmitter antenna Tx2, the SPDT RF switch 512 is coupled to the transmitter antenna Tx4, the SPDT RF switch 514 is coupled to the receiver antenna Rx2, and the SPDT RF switch 516 is coupled to the receiver antenna Rx4. The transmitted FMCW signals by two transmitter antennas are modulated by binary phase modulation (BPM) represented by 1 and −1 in FIG. 6. The reflected signal Sc and Sd are combined from the reflected signals S2 and S4 of transmitted signals transmitted by the transmitter antennas Tx2 and Tx4, and the reflected signal Sc′ and Sd′ are combined from the reflected signals S2′ and S4′ of transmitted signals transmitted by the transmitter antennas Tx2 and Tx4. The relationship can be written as follows:

$$Sc = S 2 + S 4 , Sd = S 2 - S 4 , {Sc}^{′} = S {2}^{′} = S {2}^{′} + S {4}^{′} , {Sd}^{′} = S {2}^{′} - S {4}^{′}$$

Therefore, the corresponding receiving signals S2, S4, S2′, and S4′ can be calculated as follows:

$$S 2 = \frac{Sc + Sd}{2} , S 4 = \frac{Sc - Sd}{2} , S {2}^{′} = \frac{{Sc}^{′} + {Sd}^{′}}{2} , S {4}^{′} = \frac{{Sc}^{′} - {Sd}^{′}}{2}$$

By applying BPM on the two transmitted signals, the SNR can be increased by 3 dB, and the AoA can be calculated by applying two receiving signals in two receiver antennas. However, the present invention is not limited to BPM, when the P transmitter antennas transmit the FMCW signals simultaneously, a P phase modulation (PPM) can be applied to the P transmitters.

In conclusion, the 4T4R time division duplexed (TDD) FMCW radar system reduces the power consumption and area of circuit to obtain a better AoA performance compared to the prior art.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A time division duplexed (TDD) frequency modulation continuous wave (FMCW) radar system, comprising:
P transmitter circuit chains, configured to transmit a plurality of FMCW signals, wherein a pth transmitter circuit chain is coupled to a single pole Op throw (SPQPT) radio frequency (RF) switch, the SPQPT RF switch is coupled to Qp antennas, Qp and P are positive integers, and p is a positive integer not larger than P; and
M receiver circuit chains, configured to receive a plurality of reflected FMCW signals, wherein an mth receiver circuit chain is coupled to a single pole Nm throw (SPNmT) radio frequency (RF) switch, the SPNmT RF switch is coupled to Nm antennas, Nm and M are positive integers, and m is a positive integer not larger than M.

2. The time division duplexed (TDD) frequency modulation continuous wave (FMCW) radar system of claim 1, further comprising:
an RF Phase-locked loop, coupled to the P transmitter circuit chains and the M receiver circuit chains, and configured to generate a phase-matched RF frequency signal for the plurality of FMCW signals and the plurality of reflected FMCW signals.

3. The time division duplexed (TDD) frequency modulation continuous wave (FMCW) radar system of claim 1, wherein the M receiver circuit chains comprise M mixers, configured to mix the plurality of reflected FMCW signals with the plurality of FMCW signals to generate a plurality of beat frequency signals.

4. The time division duplexed (TDD) frequency modulation continuous wave (FMCW) radar system of claim 3, wherein the plurality of beat frequency signals are analyzed to generate ranges, velocities, and angles of a plurality of objects.

5. The time division duplexed (TDD) frequency modulation continuous wave (FMCW) radar system of claim 4, wherein spectrograms of the beat frequency signals are generated by performing fast Fourier transform (FFT) on a vertical axis of the plurality of beat frequency signals, and the ranges of the plurality of objects are generated according to the spectrograms.

6. The time division duplexed (TDD) frequency modulation continuous wave (FMCW) radar system of claim 5, wherein the velocities of the plurality of objects are generated by performing fast Fourier transform (FFT) on a horizontal axis of the spectrograms of the beat frequency signals.

7. The time division duplexed (TDD) frequency modulation continuous wave (FMCW) radar system of claim 4, wherein the angles of the plurality of objects are generated by performing fast Fourier transform (FFT) on the plurality of reflected FMCW signals of the M receiver circuit chains according to phase differences of the reflected FMCW signals.

8. The time division duplexed (TDD) frequency modulation continuous wave (FMCW) radar system of claim 1, wherein the P transmitter circuit chains transmit the plurality of FMCW signals based on a P phase modulation (PPM) method.

9. The time division duplexed (TDD) frequency modulation continuous wave (FMCW) radar system of claim 1, wherein P is 2, Q1 is 2, Q2 is 2, M is 2, N1 is 2, and N2 is 2.

10. The time division duplexed (TDD) frequency modulation continuous wave (FMCW) radar system of claim 9, wherein the P transmitter circuit chains transmit the plurality of FMCW signals based on a binary phase modulation (BPM) method.

11. A method for time division duplexed (TDD) frequency modulation continuous wave (FMCW) radar system, comprising:
transmitting a plurality of FMCW signals through P transmitter circuit chains, wherein a pth transmitter circuit chain is coupled to a single pole Qp throw (SPQPT) radio frequency (RF) switch, the SPOPT RF switch is coupled to Op antennas, Qp and P are positive integers, and p is a positive integer not larger than P; and
receiving a plurality of reflected FMCW signals through M receiver circuit chains, wherein an mth receiver circuit chain is coupled to a single pole Nm throw (SPNmT) radio frequency (RF) switch, the SPNmT RF switch is coupled to Nm antennas, Nm and M are positive integers, and m is a positive integer not larger than M.

12. The method of claim 11, further comprising:
generating a phase-matched RF frequency signal through an RF Phase-locked loop for the plurality of FMCW signals and the plurality of reflected FMCW signals.

13. The method of claim 11, wherein the M receiver circuit chains comprises M mixers, and the method further comprises the M mixers mixing the plurality of reflected FMCW signals with the plurality of FMCW signals to generate a plurality of beat frequency signals.

14. The method of claim 13, further comprising analyzing the plurality of beat frequency signals to generate ranges, velocities, and angles of a plurality of objects.

15. The method of claim 14, further comprising:
performing fast Fourier transform (FFT) on a vertical axis of the plurality of beat frequency signals to generate spectrograms of the beat frequency signals; and
generating the ranges of the plurality of objects according to the spectrograms.

16. The method of claim 15, further comprising performing fast Fourier transform (FFT) on a horizontal axis of the spectrograms of the beat frequency signals to generate the velocities of the plurality of objects.

17. The method of claim 14, further comprising performing fast Fourier transform (FFT) on the plurality of reflected FMCW signals of the M receiver circuit chains according to phase differences of the reflected FMCW signals to generate the angles of the plurality of objects.

18. The method of claim 11, wherein transmitting the plurality of FMCW signals through the P transmitter circuit chains is transmitting the plurality of FMCW signals through the P transmitter circuit chains based on a P phase modulation (PPM) method.

19. The method of claim 11, wherein P is 2, Q1 is 2, Q2 is 2, M is 2, N1 is 2, and N2 is 2.

20. The method of claim 19, wherein transmitting the plurality of FMCW signals through the P transmitter circuit chains is transmitting the plurality of FMCW signals through the P transmitter circuit chains based on a binary phase modulation (BPM) method.
